(19) United States
(12) Patent Application Publication
(10) Pub. No.: US 2026/0255152 A1
(43) Pub. Date: Aug. 27, 2026

(54) METHOD FOR REMOTELY RETRIEVING AN ESIM PROFILE, ELECTRONIC DEVICE AND COMPUTER READABLE STORAGE MEDIUM

(71) Applicant: Nanning FuLian FuGui Precision Industrial Co., Ltd., Nanning (CN)

(72) Inventor: LI-REN LI, New Taipei (TW)

(21) Appl. No.: 19/064,955

(22) Filed: Feb. 27, 2025

(51) Int. Cl. H04W 8/20; H04L 9/30

(52) U.S. Cl. CPC H04W 8/20; H04L 9/30

(57) ABSTRACT

A method for remotely retrieving an eSIM profile is disclosed. A slave mobile device sends a first eSIM profile downloading request to a master mobile device of a user; obtains a public key of the master mobile device according to the first eSIM profile downloading request; sends a second eSIM profile downloading request, including the public key, to an eSIM management server; obtains an eSIM profile, encrypted using the public key by the master mobile device, corresponding to the public key from the eSIM management server; and decrypts the eSIM profile using the public key and then installs the eSIM profile.

### FIELD

The disclosure relates to a data retrieving method, and more particularly to a method for remotely retrieving an eSIM profile.

### BACKGROUND

Traditional subscriber identity module (SIM) cards can no longer meet consumers’ needs for smart and convenient life, and therefore, embedded subscriber identity module (eSIM) technology has emerged. Users can use mobile devices to download and activate eSIM to achieve independent communication and networking functions.

The eSIM has the advantages of being smaller in size and consuming less power than physical SIM cards, but eSIM may be still unable to connect when the Wi-Fi networks are shared with other mobile devices due to the long distance.

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a schematic diagram of an embodiment of a system to remotely retrieve an eSIM profile of the present disclosure;

FIG. 2 is a flowchart of an embodiment of a method to remotely retrieve an eSIM profile of the present disclosure;

FIG. 3 is a block diagram of an embodiment of a hardware architecture of an electronic device using the method of the present disclosure; and

FIG. 4 is a block diagram of an embodiment of functional blocks of an electronic device of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

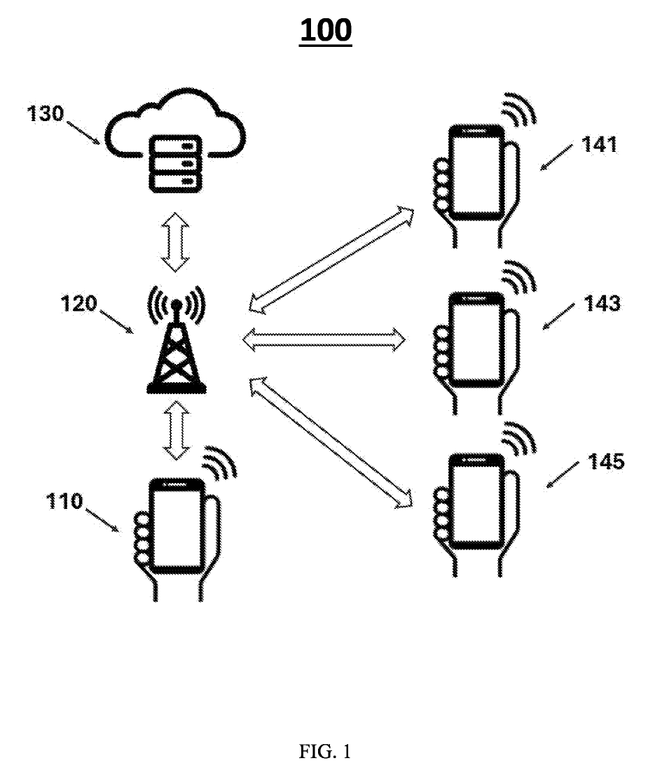

FIG. 1 is a schematic diagram of an embodiment of a system for remotely retrieving an eSIM profile of the present disclosure. The embodiment of the system for remotely retrieving an eSIM profile comprises a master mobile device 110, a base station 120, an eSIM management server 130 and slave mobile devices 141, 143 and 145. The master mobile device 110 and the slave mobile devices 141, 143 and 145 interact with the eSIM management server 130 via the base station 120.

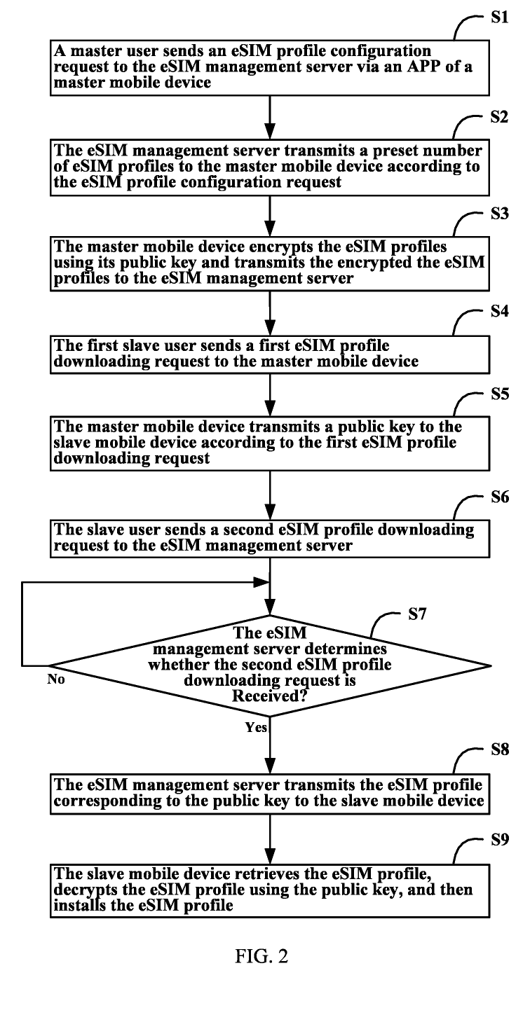

FIG. 2 is a flowchart of an embodiment of a method for remotely retrieving an eSIM profile of the present disclosure. According to different needs, the order of the steps in the flowchart can be changed, and some steps can be omitted.

In step S1, a master user sends an eSIM profile configuration request to the eSIM management server 130 via a mobile application (APP) of the master mobile device 110.

In step S2, the eSIM management server 130 receives the eSIM profile configuration request from the master mobile device 110 and transmits a preset number of eSIM profiles, for example, 3 eSIM profiles, eSIM Profile 1 to eSIM Profile 3, to the master mobile device 110 according to the eSIM profile configuration request.

In step S3, the master mobile device 110 obtains the eSIM profiles, encrypts the eSIM profiles, for example, encrypting the first eSIM profile (eSIM Profile 1) using its public key, and transmits the encrypted first eSIM profile to the eSIM management server 130. It should be noted that the master mobile device 110 may also encrypt the eSIM profiles using specific information of the slave users (for example, the first slave user, the second slave user and the third slave user) or the slave mobile devices 141, 143 and 145 of the slave users.

For example, the first eSIM profile (eSIM Profile 1) to be configured for the slave mobile device 141 may be encrypted a second time based on facial recognition result of the first slave user or the International Mobile Equipment Identity (IMEI) of the slave mobile device 141 (the first slave mobile device) of the first slave user to enhance security, thereby ensuring that only the slave mobile device 141 can download the first eSIM profile.

In step S4, when the first slave user wants to download the first eSIM profile, the first slave user sends a first eSIM profile downloading request to the master mobile device 110 via the APP of the slave mobile device 141.

In step S5, the master mobile device 110 receives the first eSIM profile downloading request and transmits the public key of the master mobile device 110 to the slave mobile device 141 according to the first eSIM profile downloading request.

In step S6, the first slave user sends a second eSIM profile downloading request to the eSIM management server 130 via the APP of the slave mobile device 141. The second eSIM profile downloading request includes the public key.

In step S7, the eSIM management server 130 determines whether the second eSIM profile downloading request is received from the slave mobile device 141.

In step S8, if the second eSIM profile downloading request is received from the slave mobile device 141, the eSIM management server 130 transmits the first eSIM profile corresponding to the public key to the slave mobile device 141.

It should be noted that if the master mobile device 110 only uses the public key of the master mobile device 110 to encrypt the eSIM profile, and the eSIM management server 130 has multiple encrypted eSIM profiles, the eSIM management server 130 selects and transmits one of the eSIM profile to the slave mobile device 141. If the master mobile device 110 encrypts the eSIM profile using the public key of the master mobile device 110 and the IMEI of the slave mobile device 141, the eSIM management server 130 must transmit the eSIM profile corresponding to the public key and the IMEI of the slave mobile device 141 to the slave mobile device 141.

In Step S9, the slave mobile device 141 retrieves the first eSIM profile, decrypts the first eSIM profile using the public key, and then installs the first eSIM profile. It should be noted that in step S3, if the face recognition result or the IMEI is used to encrypt the first eSIM profile, the face recognition result or the IMEI is also needed to decrypt the first eSIM profile during decryption.

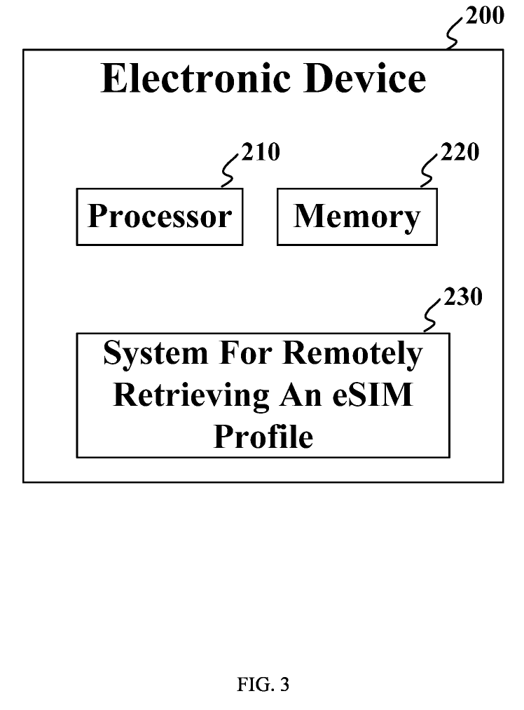

FIG. 3 is a block diagram of an embodiment of the hardware architecture of an electronic device using the method for remotely retrieving an eSIM profile of the present disclosure. The electronic device 200 may be, but is not limited to, connected to a processor 210, a memory 220, and a system for remotely retrieving an eSIM profile 230 via system buses. The electronic device 200 shown in FIG. 3 may include more or fewer components than those illustrated or may combine certain components.

The memory 220 stores a computer program, such as the system for remotely retrieving an eSIM profile 230, which is executable by the processor 210. When the processor 210 executes the system for remotely retrieving an eSIM profile 230, the blocks in one embodiment of the booting mode configuration method applied in the electronic device 200 are implemented, such as blocks S1 to S9 shown in FIG. 1.

It will be understood by those skilled in the art that FIG. 3 is merely an example of the electronic device 200 and does not constitute a limitation to the electronic device 200. The electronic device 200 may include more or fewer components than those illustrated or may combine certain components. The electronic device 200 may also include input and output devices, network access devices, buses, and the like.

The processor 210 may be a central processing unit (CPU), or other general-purpose processors, a digital signal processor (DSP), an application specific integrated circuit (ASIC), a Field-Programmable Gate Array (FPGA), or another programmable logic device, discrete gate or transistor logic device, discrete hardware components, or the like. The processor 210 may be a microprocessor or other processor known in the art.

The memory 220 can be used to store the system for remotely retrieving an eSIM profile 230 and/or modules/units by running or executing computer programs and/or modules/units stored in the memory 220. The memory 220 may include a storage program area and a storage data area. In addition, the memory 220 may include a high-speed random access memory, a non-volatile memory such as a hard disk, a plug-in hard disk, a smart memory card (SMC), and a secure digital (SD) card, flash card, at least one disk storage device, flash device, or another volatile solid state storage device.

The system for remotely retrieving an eSIM profile 230 can be partitioned into one or more modules/units that are stored in the memory 220 and executed by the processor 210. The one or more modules/units may be a series of computer program instructions capable of performing particular functions of the system for remotely retrieving an eSIM profile 230.

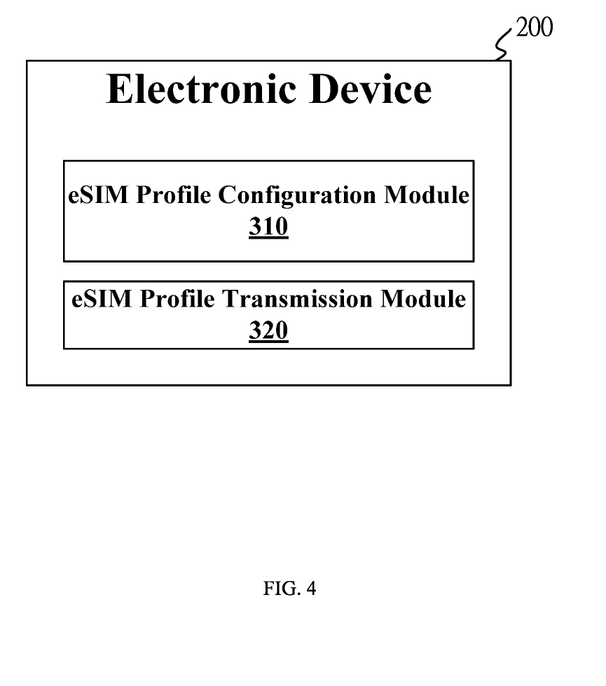

FIG. 4 is a schematic diagram of an embodiment of functional blocks of the electronic device using the method of the present disclosure.

The electronic device 200 comprises an eSIM profile configuration module 310 and an eSIM profile transmission module 320.

The eSIM profile configuration module 310 receives an eSIM profile configuration request from a master mobile device of a master user, transmits a preset number of eSIM profiles to the master mobile device according to the eSIM profile configuration request, and then receives encrypted eSIM profiles from the master mobile device.

The master mobile device retrieves the eSIM profiles, uses its public key to encrypt the eSIM profiles and transmits the encrypted eSIM profiles back to the eSIM profile configuration module 310.

It should be noted that the master mobile device may also encrypt an eSIM profiles using the specific information of a slave user or a slave mobile device of the slave user. For example, the eSIM profile to be configured for the slave mobile device may be encrypted a second time based on facial recognition result of the slave user or the IMEI of the slave mobile device of the slave user to enhance security, thereby ensuring that only the slave mobile device can download the eSIM profile.

The eSIM profile transmission module 320 determines whether an eSIM profile downloading request is received from the slave mobile device. The eSIM profile downloading request includes a public key. If the eSIM profile downloading request is received, the eSIM profile transmission module 320 transmits the eSIM profile corresponding to the public key to the slave mobile device.

The slave mobile device retrieves the eSIM profile, decrypts the eSIM profile using the public key, and then installs the eSIM profile. It should be noted that, if the face recognition result or the IMEI is used to encrypt the first eSIM profile, the face recognition result or the IMEI is also needed to decrypt the first eSIM profile during decryption.

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method to remotely retrieve an eSIM profile and executable by an electronic device, the method comprising:
a master user sending an eSIM profile configuration request to an eSIM management server via a mobile application (APP) of a master mobile device of the master user;
the eSIM management server receiving the eSIM profile configuration request from the master mobile device, and transmitting at least one eSIM profile to the master mobile device according to the eSIM profile configuration request;
the master mobile device retrieving the at least one eSIM profile, encrypting the at least one eSIM profile by using a public key of the master mobile device, and transmitting the encrypted at least one eSIM profile to the eSIM management server;
a slave user sending a first eSIM profile downloading request to the master mobile device via an APP of a slave mobile device of the slave user;
the master mobile device receiving the first eSIM profile downloading request and transmits the public key of the master mobile device to the slave mobile device according to the first eSIM profile downloading request;
the slave user sending a second eSIM profile downloading request to the eSIM management server via the APP of the slave mobile device, wherein the second eSIM profile downloading request includes the public key;
the eSIM management server determines whether the second eSIM profile downloading request is received from the slave mobile device;
if the second eSIM profile downloading request is received from the slave mobile device by the eSIM management server, the eSIM management server transmitting the at least one eSIM profile corresponding to the public key to the slave mobile device; and
the slave mobile device retrieving the at least one eSIM profile, decrypting the at least one eSIM profile using the public key, and installing the at least one eSIM profile.

2. The method of claim 1, wherein:
the master mobile device encrypting the at least one eSIM profile a second time based on facial recognition result of the slave user or International Mobile Equipment Identity (IMEI) of the slave mobile device.

3. The method of claim 2, further comprising:
the slave mobile device further decrypting the at least one eSIM profile using the facial recognition result or the IMEI.

4. An electronic device including a memory, a processor, and a program configured for remotely retrieving an eSIM profile, wherein the program is stored in the memory and operable by the processor; the program is executed by the processor to implement following instructions:
sending a first eSIM profile downloading request to a master mobile device of a user;
obtaining a public key of the master mobile device according to the first eSIM profile downloading request;
sending a second eSIM profile downloading request to an eSIM management server, wherein the second eSIM profile downloading request includes the public key;
retrieving an eSIM profile corresponding to the public key from the eSIM management server, wherein the master mobile device encrypts the eSIM profile using the public key; and
decrypting the eSIM profile using the public key and then installing the eSIM profile.

5. The device of claim 4, wherein the program for remotely retrieving an eSIM profile is further executed by the processor to implement following instructions:
retrieving the eSIM profile corresponding to the public key from the eSIM management server, wherein the master mobile device encrypts the eSIM profile a second time based on facial recognition result of a slave user or International Mobile Equipment Identity (IMEI) of the electronic device.

6. The device of claim 5, wherein the program for remotely retrieving an eSIM profile is further executed by the processor to implement following instructions:
decrypting the eSIM profile using the facial recognition result or the IMEI.

7. A non-transitory computer-readable storage medium storing a game program which causes a computer to execute:
a process of a master user sending an eSIM profile configuration request to an eSIM management server via a mobile application (APP) of a master mobile device of the master user;
a process of the eSIM management server receiving the eSIM profile configuration request from the master mobile device, and transmitting at least one eSIM profile to the master mobile device according to the eSIM profile configuration request;
a process of the master mobile device retrieving the at least one eSIM profile, encrypting the at least one eSIM profile by using a public key of the master mobile device, and transmitting the encrypted at least one eSIM profile to the eSIM management server;
a process of a slave user sending a first eSIM profile downloading request to the master mobile device via an APP of a slave mobile device of the slave user;
a process of the master mobile device receiving the first eSIM profile downloading request and transmits the public key of the master mobile device to the slave mobile device according to the first eSIM profile downloading request;
a process of the slave user sending a second eSIM profile downloading request to the eSIM management server via the APP of the slave mobile device, wherein the second eSIM profile downloading request includes the public key;
a process of the eSIM management server determines whether the second eSIM profile downloading request is received from the slave mobile device;
a process of if the second eSIM profile downloading request is received from the slave mobile device by the eSIM management server, the eSIM management server transmitting the at least one eSIM profile corresponding to the public key to the slave mobile device; and
a process of the slave mobile device retrieving the at least one eSIM profile, decrypting the at least one eSIM profile using the public key, and installing the at least one eSIM profile.

8. The non-transitory computer-readable storage medium of claim 7, wherein the game program causes a computer to execute:
a process of the master mobile device encrypting the at least one eSIM profile a second time based on facial recognition result of the slave user or International Mobile Equipment Identity (IMEI) of the slave mobile device.

9. The non-transitory computer-readable storage medium of claim 8, wherein the game program causes a computer to execute:
a process of the slave mobile device further decrypting the at least one eSIM profile using the facial recognition result or the IMEI.
